(19) United States
(12) Patent Application Publication
(10) Pub. No.: US 2017/0124257 A1
(43) Pub. Date: May 4, 2017

(54) SUPPLEMENTING SEGREGATED SECURE DATA STREAM USING A METADATA MANAGEMENT SUBSYSTEM

(71) Applicants: AT&T Intellectual Property I, L.P., Atlanta, GA (US); AT&T Mobility II LLC, Atlanta, GA (US)

(72) Inventors: Sangar Dowlatkhah, Johns Creek, GA (US); Erie Lai Har Lau, Redmond, WA (US)

(21) Appl. No.: 14/929,897

(22) Filed: Nov. 2, 2015

(51) Int. Cl. G06F 19/00; H04L 29/06

(52) U.S. Cl. CPC G06F 19/322; G06F 19/3418; H04L 63/04

(57) ABSTRACT

A system for attaching metadata to a secure data stream is provided. A device associated with a patient can transmit a secure data stream comprising electronic personal health information another device. Due to federal regulations, the data stream is secure and cannot be accessed in order to provide additional services. By collecting contextual data from the patient device and other devices associated with the patient, a metadata management system can determine what contextual data is relevant, and attach the relevant contextual data as metadata to the secure data stream in order to provide supplemental services, improve quality of experience, and to provide a healthcare provider additional context when interpreting the electronic personal health information.

### TECHNICAL FIELD

The subject disclosure relates to supplementing a secure data stream with a metadata management subsystem in a wireless communication environment.

### BACKGROUND

In order to provide more personalized healthcare to more patients, devices can allow patients to send electronic personal health information to doctors and to monitoring databases. Electronic personal health information is federally regulated, however, and there are strict rules for how mobile applications have to enforce security measures and policies rules at the application layers on the mobile side and at the data storage on the server side. As a result, the data streams between monitoring devices and the doctors are secure and mobile networks cannot access the data within the data streams.

### BRIEF DESCRIPTION OF THE DRAWINGS

FIG. 1 is an example, non-limiting embodiment of a block diagram showing a metadata management system that provides contextual metadata for a secure data stream between two devices in accordance with various aspects described herein.

FIG. 2 is an example, non-limiting embodiment of a block diagram showing a metadata management system that provides contextual metadata for a secure data stream between two devices in accordance with various aspects described herein.

FIG. 3 is an example, non-limiting embodiment of a block diagram showing a metadata management system that provides contextual metadata for secure data streams from one device to two devices in accordance with various aspects described herein.

FIG. 4 is an example, non-limiting embodiment of a block diagram showing a metadata management system that provides contextual metadata for a secure data stream between device using a mobile network in accordance with various aspects described herein.

FIG. 5 is an example, non-limiting embodiment of a block diagram showing a metadata management system in accordance with various aspects described herein.

FIG. 6 is an example, non-limiting embodiment of a block diagram showing a metadata management system in accordance with various aspects described herein.

FIG. 7 illustrates a flow diagram of an example, non-limiting embodiment of a method for providing contextual metadata for a secure data stream between devices as described herein.

FIG. 8 illustrates a flow diagram of an example, non-limiting embodiment of a method for providing contextual metadata for a secure data stream between devices as described herein.

FIG. 9 is a block diagram of an example, non-limiting embodiment of a computing environment in accordance with various aspects described herein.

FIG. 10 is a block diagram of an example, non-limiting embodiment of a mobile network platform in accordance with various aspects described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

In one or more embodiments, a system for attaching metadata to a secure data stream is provided. A device associated with a patient can transmit a secure data stream comprising electronic personal health information another device. Due to federal regulations, the data stream is secure and cannot be accessed in order to provide additional services. By collecting contextual data from the patient device and other devices associated with the patient, a metadata management system can determine what contextual data is relevant, and attach the relevant contextual data as metadata to the secure data stream in order to provide supplemental services, improve quality of experience, and to provide a healthcare provider additional context when interpreting the electronic personal health information.

In an embodiment, for a health care provider to determine how to interpret the electronic personal health information from a patient, relevant contextual data from multiple sources can be used. The supplemental information can include the location of the data source, the environmental conditions when the data was created (e.g., weather) and other information in order to draw meaningful conclusions. The relevant contextual data can also be used to predict the incoming secure data streams in real time from a source by correlating similar data from similar situations (e.g., illnesses) from metadata attached to other secure data streams. For example, a doctor can predict the level of insulin in the patient's blood by correlating the data from a similar study with similar patient demographics.

Accordingly, a metadata management system can be provided to collect, compile, and distribute metadata dynamically and in real time to segregated secure data streams. The metadata management system can gather information from multiple existing sources such as subscriber's devices and home sensory devices (device location, smart thermostats, etc.), big data, traffic detection (from carrier network perspective), supplementary services providers, and similar research data from research institutes.

For these considerations as well as other considerations, in one or more embodiments, a system comprises a processor and a memory that stores executable instructions that, when executed by the processor, facilitate performance of operations, comprising receiving a secure data stream from a first device, wherein the secure data stream comprises personal healthcare information representing a health characteristic of an identity associated with a person. The operations also comprise receiving contextual information via a metadata aggregator that aggregates metadata associated with the first device. The operations also comprise determining, from the contextual information, relevant contextual information that is related to the personal healthcare information and transmitting the secure data stream and the relevant contextual information, as stream metadata associated with the secure data stream, to a second device.

In another embodiment, a method comprises relaying, by a device comprising a processor, a secure data stream from a first device to a second device, wherein the secure data stream comprises personal healthcare information representing a health characteristic of an identity associated with a person. The method also comprises receiving, by the device, contextual information via a metadata aggregator that aggregates metadata associated with the first device. The method also comprises determining, by the device, from the contextual information, relevant contextual information that is related to the personal healthcare information. The method can also comprise attaching, by the device, the relevant contextual information as stream metadata to the secure data stream before transmitting the stream metadata and the secure data stream to the second device.

In another embodiment, a machine-readable storage medium, comprising executable instructions that, when executed by a processor, facilitate performance of operations comprising relaying, by a device comprising a processor, a secure data stream from a first device to a second device, wherein the secure data stream comprises personal healthcare information representing a health characteristic of an identity associated with a person. The operations also comprise receiving, by the device, contextual information via a metadata aggregator that aggregates metadata associated with the first device. The operations further comprise determining, by the device, from the contextual information, relevant contextual information that is related to the personal healthcare information and attaching, by the device, the relevant contextual information as stream metadata to the secure data stream before transmitting the stream metadata and the secure data stream to the second device.

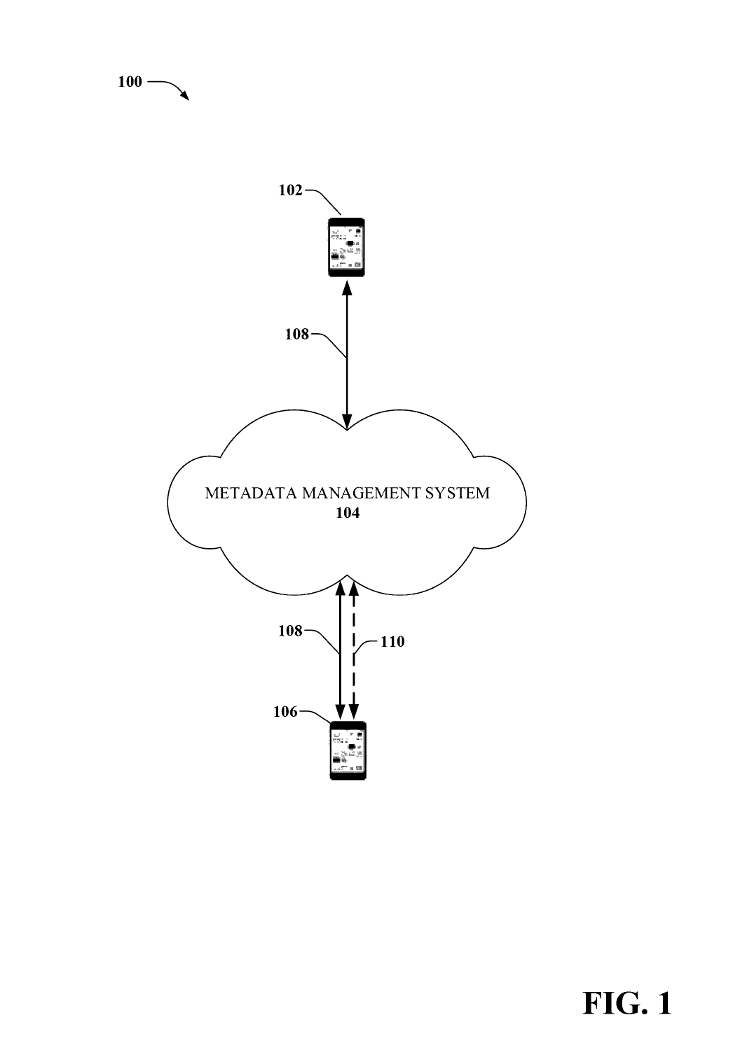

Turning now to FIG. 1, illustrated is an example, non-limiting embodiment of a block diagram 100 showing a metadata management system 104 that provides contextual metadata for a secure data stream between two devices in accordance with various aspects described herein.

Metadata management system 104 can reside on a mobile broadband network that comprises a radio access network that facilitates communications between the devices 102 and 106 and a core network. In the case of Long Term Evolution (“LTE”) networks and other 3rd Generation Partnership Project (“3GPP”) compliant networks (e.g., LTE Advanced) and even non-3GPP systems such as WiMAX and CDMA2000, these networks are the radio access network and an evolved packet core network that can contain a series of components that provide mobile data and control management. The metadata management system disclosed herein can be utilized in a network that comprises base station devices (eNodeBs) and Wi-Fi access points and other network access points. In some embodiments, the metadata management system can be operable with user equipment or networked devices that are not directly attached to a mobile network system but rather have wireline networked access. For the sake of simplicity, throughout this application, reference will be made to a mobile network, but the subject matter disclosed herein can be operable in any networked environment.

In an embodiment, device 102 can send a secure data stream 108 to another device 106. A metadata management system 104 can receive the secure data stream 108 from device 102 and relay the secure data stream to device 106 while also attaching metadata stream 110 to the secure data stream 108. The metadata stream 110 can be relevant contextual data that can be used by a user of device 106 to provide context about the secure data stream 108.

In an embodiment the secure data stream 108 can comprise electronic personal health information that is protected by federal regulations. The electronic personal health information can represent a health characteristic of an identity associated with a person. Device 102 can be a monitoring device associated with a user or patient that monitors or records vital signs or other health information associated with the user. Device 102 can also be a mobile device with an application installed the permits transfer of secure data to a doctor or health care provider. Device 106 can be a computer, laptop, or other mobile device used by a health care provider, doctor, or other person in order to monitor, examine, diagnose, or otherwise examine the electronic personal health information received from device 102.

The metadata management system can receive the secure data stream 108 from device 102 and relay the secure data stream 108 to device 106. The metadata management system 104 can receive contextual information via a metadata aggregator that aggregates metadata associated with device 102 and the user and/or user account associated with device 102. The contextual information can come from the device 102, from other devices associated with user of device 102, can come from the mobile network, and can come from other sources, such as research institutions, big data, metadata brokers, home sensory devices, traffic data, supplemental service providers, and other sources. The contextual data can include data related to the device 102, or received via sensors on device 102 or other devices. The sensory data can include accelerometer data, audio or visual data, temperature data, other weather and/or environmental data. The data can also include location information (e.g., GPS coordinates). In some embodiments, the location information can be correlated with mapping data to describe qualitatively where the device 102 is located (e.g., amusement park, shopping center, etc.). The location information and environmental information can in some embodiments come directly from device 102, whereas in other embodiments, the data can originate from a core network management device on a mobile network associated with metadata management system 104. The core network management device can be a packet data gateway or other component of an evolved packet core network.

Once the contextual data has been collected by the metadata management system 104, the metadata management system can determine which of the contextual information is relevant to the secure data stream 108. Once the relevant contextual information is determined, the metadata management system 104 can send the relevant contextual information as stream metadata 110 attached or associated with the secure data stream 108 to the device 106.

The metadata management system 104 can determine what data is relevant based on user account information associated with the user account of device 102. For instance, if a person has a medical diagnosis which may be indicated in the user account, contextual information that may be related to the medical diagnosis can be determined to be relevant. The age of the user may also determine what data is relevant. In other embodiments, the metadata management system 104 can determine what data is relevant based on a variation from past contextual information. For instance, if a person regularly commutes to work at a specific time, the location information and time stamp can indicate that a person has missed a commute, or is late, and so the metadata management system 104 can determine that the information indicating the missed commute is relevant. Likewise, if temperature data indicates that the device 102 or its surroundings/environs are at a different temperature than usual, then metadata management system 104 can determine that the temperature data is relevant.

In other embodiments, the metadata management system 104 can determine what data is relevant based on information associated with device 106. For instance, if the user account associated with device 106 is related to a particular medical specialty (e.g., cardiac, pulmonary, etc) then metadata management system 104 can determine the relevant contextual data based on contextual data that may be related to the medical specialty. In other embodiments, metadata management system 104 can determine what information is relevant based on requests for information from device 106. User device 106 can sends requests related to specific concerns, and metadata management system 104 can collect contextual data based on the request and send that metadata as stream metadata 110 to device 106.

In some embodiments, metadata management system 104 can also provide supplemental services for device 106 based on the relevant contextual information. A set of services to enhance quality of experience for the user of device 106 can be provided, and the metadata management system 104 can select services to offer to user device 106 based on the relevant contextual information, and send an offer by transmitting offer information representative of an offer for the service to the user device 106. A service of the set of services can include a listing of locations over time that the device 102 has been to. The services can also include other services such as estimating sleeping schedules, eating schedules, caloric intake, exercise amounts, and other information that can be gleaned from the relevant contextual information.

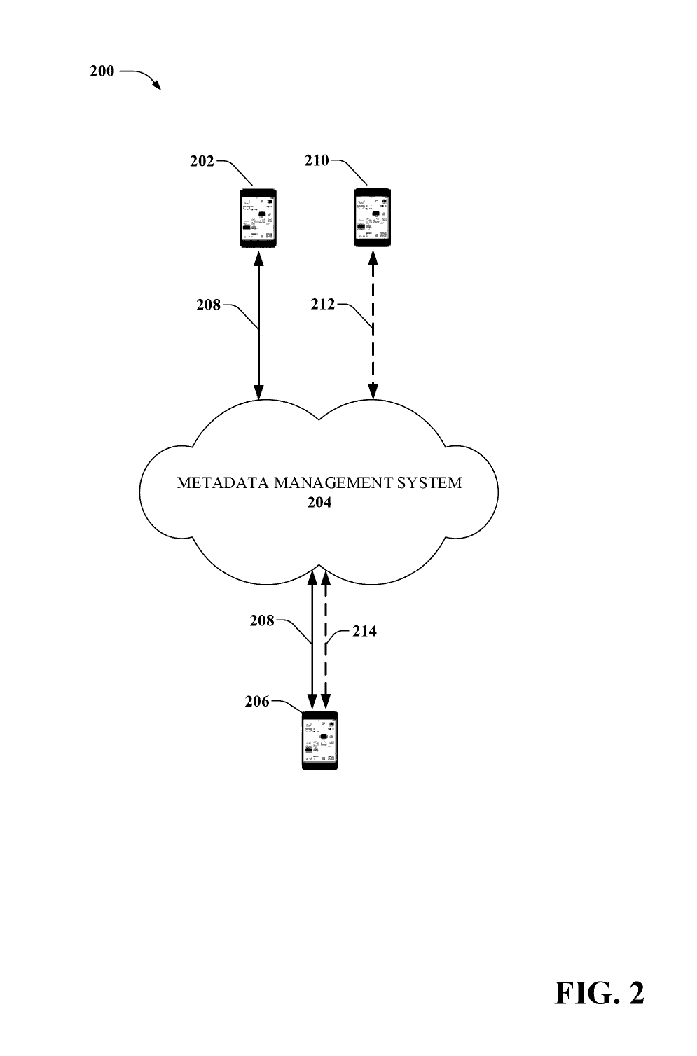

Turning now to FIG. 2, illustrated is an example, non-limiting embodiment of a block diagram 200 showing a metadata management system 204 that provides contextual metadata for a secure data stream 208 between two devices 202 and 206 in accordance with various aspects described herein.

In an embodiment, device 202 can send a secure data stream 208 to another device 206. A metadata management system 204 can receive the secure data stream 208 from device 202 and relay the secure data stream to device 206 while also attaching metadata stream 214 to the secure data stream 208. The metadata stream 214 can be relevant contextual data that can be used by a user of device 206 to provide context about the secure data stream 208. The relevant contextual data in metadata stream 214 can be derived from contextual data 212 received from another user device 210.

In an embodiment the secure data stream 208 can comprise electronic personal health information that is protected by federal regulations. The electronic personal health information can represent a health characteristic of an identity associated with a person. Device 202 can be a monitoring device associated with a user or patient that monitors or records vital signs or other health information associated with the user. Device 210 can be a mobile device associated with the user of device 202 and can be used to transfer contextual data 212 about the user or the environment to metadata management system 204. Device 206 can be a computer, laptop, or other mobile device used by a health care provider, doctor, or other person in order to monitor, examine, diagnose, or otherwise examine the electronic personal health information received from device 202.

The metadata management system can receive the secure data stream 208 from device 202 and relay the secure data stream 208 to device 206. The metadata management system 204 can receive contextual information 212 via a metadata aggregator that aggregates metadata received from device 210 that has a user and/or user account associated with device 202. In an embodiment, device 202 can be a monitoring or recording device capable of streaming personal health information to device 206, but in some embodiments, may not include additional sensors to record other contextual data. If the user of device 202 also has a device 210 that may include additional sensors (e.g., a mobile device) that device 210 can be used to transfer contextual data 212 to metadata management system 204.

The contextual data can include data related to the device 210, or received via sensors on device 210. The sensory data can include accelerometer data, audio or visual data, temperature data, other weather and/or environmental data. The data can also include location information (e.g., GPS coordinates). In some embodiments, the location information can be correlated with mapping data to describe qualitatively where the device 210 is located (e.g., amusement park, shopping center, etc.), and thus by extension, device 202. The location information and environmental information can in some embodiments come directly from device 210, whereas in other embodiments, the data can originate from a network management device on a mobile network associated with metadata management system 204.

Once the contextual data has been collected by the metadata management system 204, the metadata management system can determine which of the contextual information 212 is relevant to the secure data stream 208. Once the relevant contextual information is determined, the metadata management system 204 can send the relevant contextual information as stream metadata 214 attached or associated with the secure data stream 208 to the device 206.

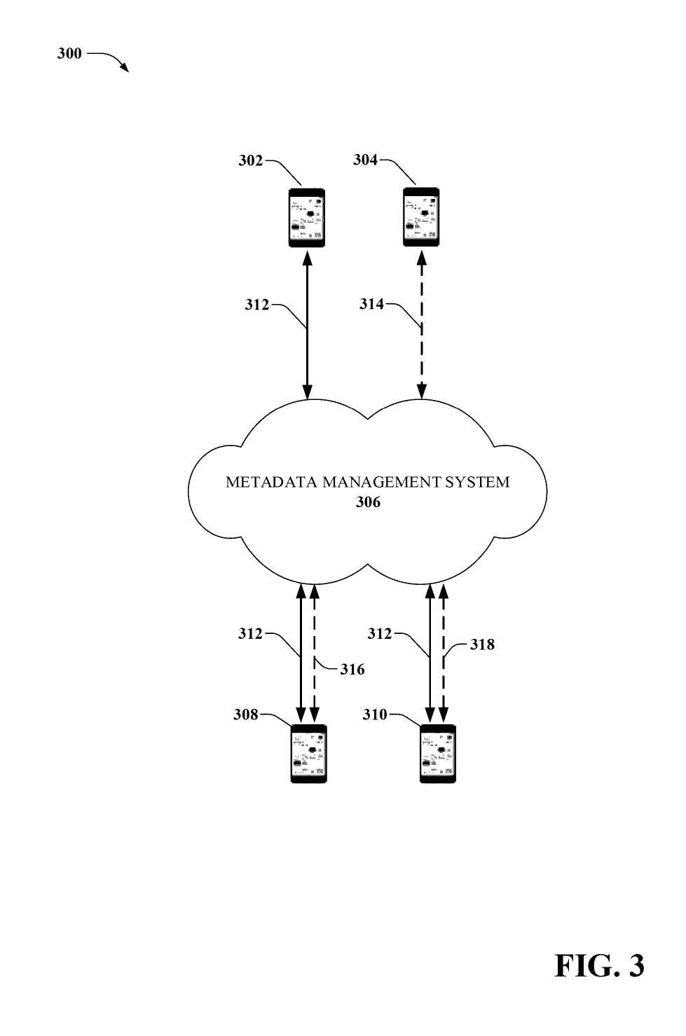

Turning now to FIG. 3, illustrated is an example, non-limiting embodiment of a block diagram 300 showing a metadata management system 306 that provides contextual metadata for secure data streams 312 from one device (e.g., device 302) to two devices (e.g., device 308 and 310) in accordance with various aspects described herein.

In an embodiment, device 302 can send a secure data stream 312 to devices 308 and 310. A metadata management system 306 can receive the secure data stream 312 from device 302 and relay the secure data stream 312 to devices 308 and 310 while also attaching metadata streams 316 and 318 to the secure data stream 312 going to devices 308 and 310 respectively. The metadata streams 316 and 318 can be relevant contextual data selected by metadata management system 306 from a set of contextual data 314 received from device 304. The metadata streams 316 and 318 can be tailored based on the user account information associated with each of devices 308 and 310.

In an embodiment the secure data stream 312 can comprise electronic personal health information that is protected by federal regulations. The electronic personal health information can represent a health characteristic of an identity associated with a person. Device 302 can be a monitoring device associated with a user or patient that monitors or records vital signs or other health information associated with the user. Device 304 can be a mobile device associated with the user of device 302 and can be used to transfer contextual data 314 about the user or the environment to metadata management system 306.

The metadata management system 306 can determine what data is relevant based on information associated with devices 308 and 310. For instance, if the user account associated with device 308 is related to a particular medical specialty (e.g., cardiac, pulmonary, etc) then metadata management system 306 can determine the relevant contextual data based on contextual data that may be related to the medical specialty. Likewise, metadata management system 306 can tailor the relevant contextual data to device 310 based on account information associated with device 310.

In other embodiments, metadata management system 306 can determine what information is relevant based on requests for information from devices 308 or 310. User devices 308 or 310 can sends requests related to specific concerns, and metadata management system 306 can collect contextual data based on the request and send that metadata as stream metadata 316 and 318 to devices 308 and 310 respectively.

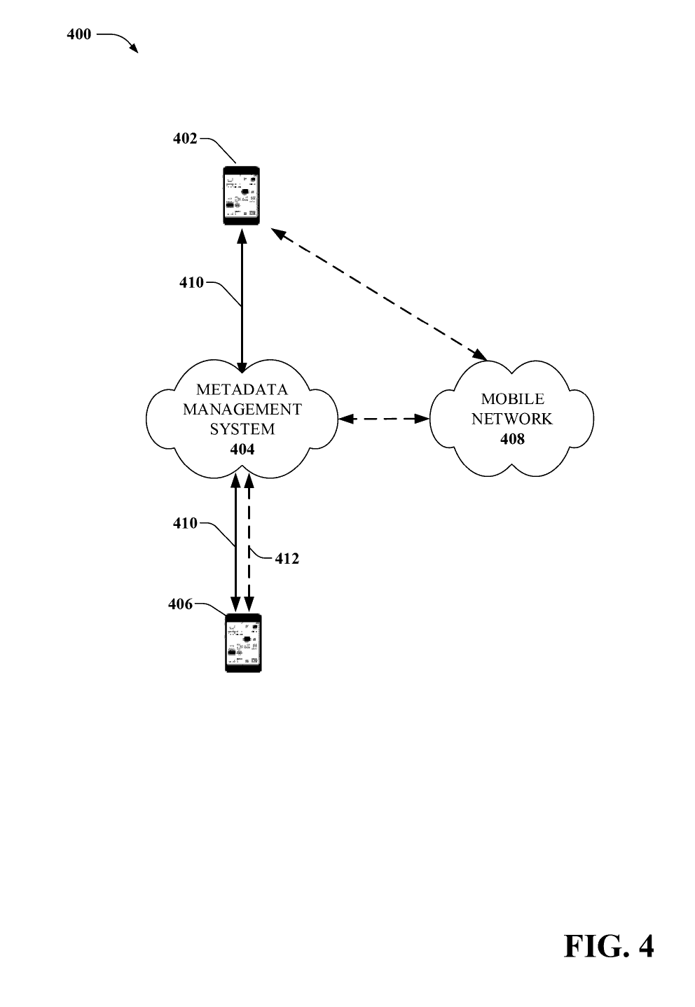

Turning now to FIG. 4, illustrated is an example, non-limiting embodiment of a block diagram 400 showing a metadata management system 404 that provides relevant contextual metadata 412 for a secure data stream 410 between devices 402 and 406, where the contextual data arrives via a mobile network 408 in accordance with various aspects described herein.

In an embodiment, device 402 can send a secure data stream 410 to device 406. A metadata management system 404 can receive the secure data stream 410 from device 402 and relay the secure data stream 410 to device 406 while also attaching metadata stream 412 to the secure data stream 410 going to device 406. The metadata stream 412 can be relevant contextual data selected by metadata management system 404 from a set of contextual data received from mobile network 408. The contextual data received from the mobile network 408 can be from a network management device that determines the location of the device 402, and determine other contextual information about device 402.

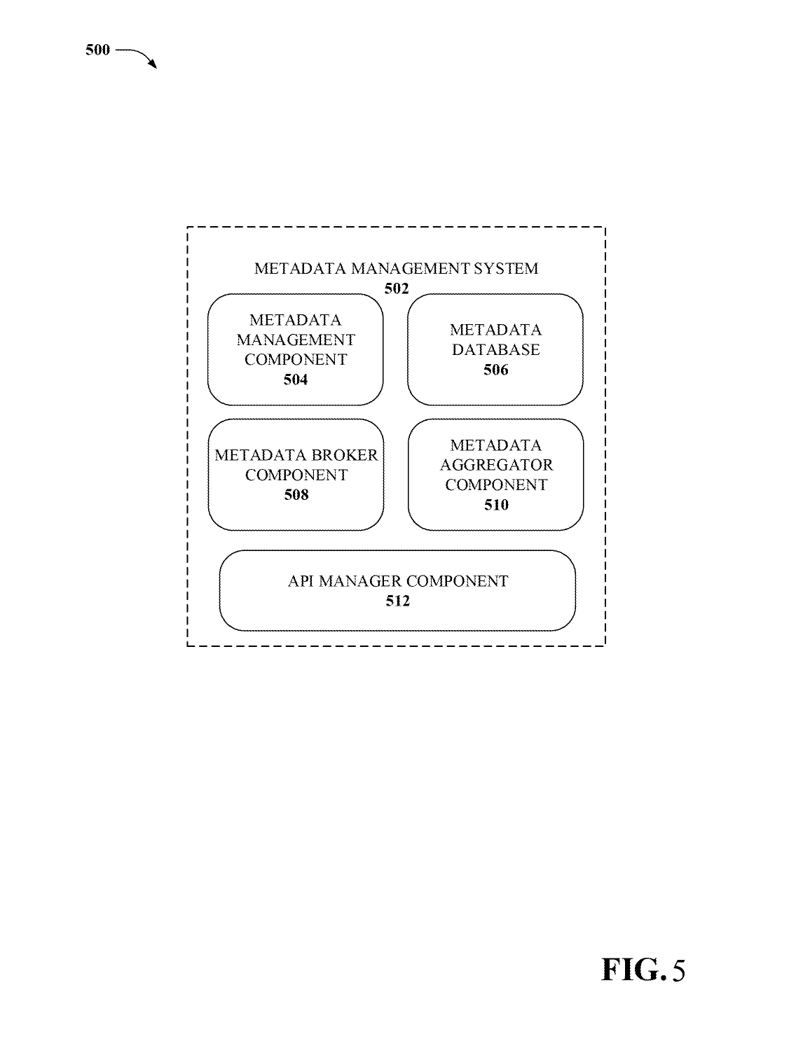

Turning now to FIG. 5, illustrated is an example, non-limiting embodiment of a block diagram 500 showing a metadata management system 502 in accordance with various aspects described herein.

In an embodiment, metadata management system can add contextual metadata to a secure data stream by collecting contextual data associated with the secure data stream or the device from which the data stream originates, and then determine which of the contextual data is relevant, and then attach the relevant contextual data as a metadata stream to the secure data stream before the secure data stream is transmitted to the receiving device.

The metadata management system 502 can include a metadata broker component 508 that communicates with all available metadata sources and acts as a broker to not only collect information but also provide metadata for other service providers as a service.

A metadata aggregator component 510 compiles and provides metadata information about various data streams, and a metadata management component 504 manages difference sources for metadata and intelligently prioritizes and manages the metadata depending on the source and nature of the secure data stream. A metadata database 506 can store metadata, and an API (application program interface) manager component 512 can enable access to metadata systems by user devices, as well as communicate with other platforms.

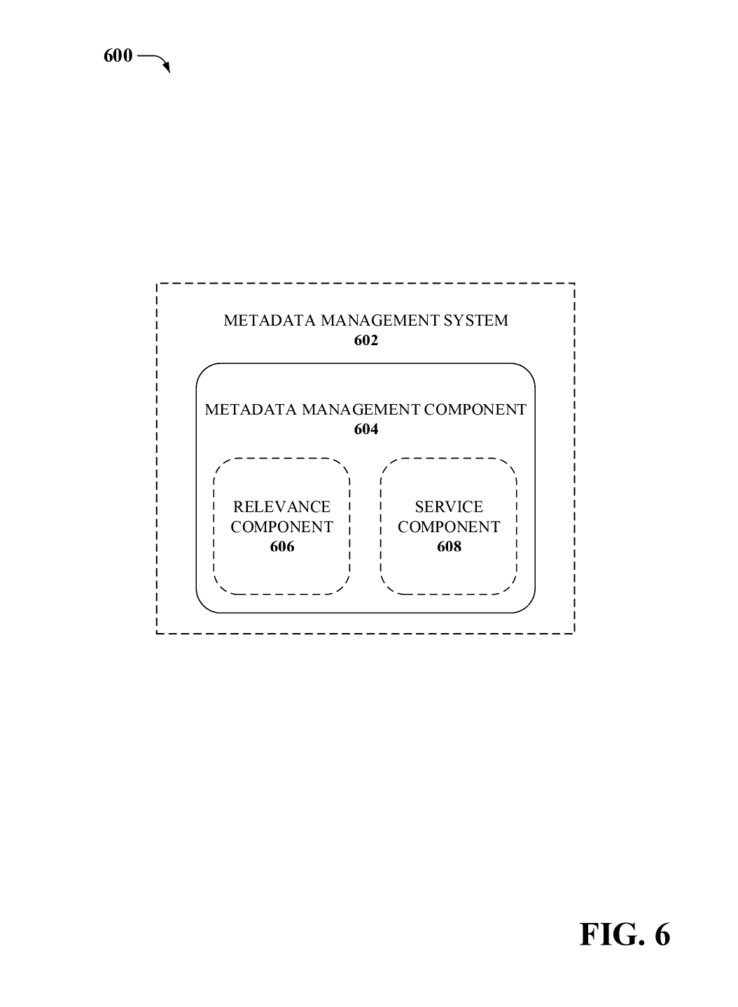

Turning now to FIG. 6, illustrated is an example, non-limiting embodiment of a block diagram 600 showing a metadata management system 602 in accordance with various aspects described herein. The embodiment shown in FIG. 6 can be a more detailed depiction of the embodiment shown in FIG. 5, where the metadata management component 604 can include a relevance component 606 and a service component 608. The relevance component 606 can determine what contextual data collected by the metadata management system is relevant, while service component 608 can offer additional and/or supplemental services based on the metadata and the user accounts.

The relevance component 606 can determine what data is relevant based on user account information associated with the user account of the device from which the secure stream originates. For instance, if a person has a medical diagnosis which may be indicated in the user account, contextual information that may be related to the medical diagnosis can be determined to be relevant. The age of the user may also determine what data is relevant. In other embodiments, the relevance component 606 can determine what data is relevant based on a variation from past contextual information. For instance, if a person regularly commutes to work at a specific time, the location information and time stamp can indicate that a person has missed a commute, or is late, and so the relevance component 606 can determine that the information indicating the missed commute is relevant. Likewise, if temperature data indicates that the device or its surroundings/environs are at a different temperature than usual, then relevance component 606 can determine that the temperature data is relevant.

In other embodiments, the relevance component 606 can determine what data is relevant based on information associated with the device to which the secure data stream is being transmitted. For instance, if the user account associated with the device is related to a particular medical specialty (e.g., cardiac, pulmonary, etc) then relevance component 606 can determine the relevant contextual data based on contextual data that may be related to the medical specialty. In other embodiments, relevance component 606 can determine what information is relevant based on requests for information from the device. The user device can also sends requests related to specific concerns, and relevance component 606 can collect contextual data based on the request and send that metadata as stream metadata to the device.

In some embodiments, service component 608 can also provide supplemental services for device to which the secure stream is being transmitted based on the relevant contextual information. A set of services to enhance quality of experience for the user of device can be provided, and the service component 608 can select services to offer to the user device based on the relevant contextual information, and send an offer by transmitting offer information representative of an offer for the service to the user device. A service of the set of services can include a listing of locations over time that the originating device has been to. The services can also include other services such as estimating sleeping schedules, eating schedules, caloric intake, exercise amounts, and other information that can be gleaned from the relevant contextual information.

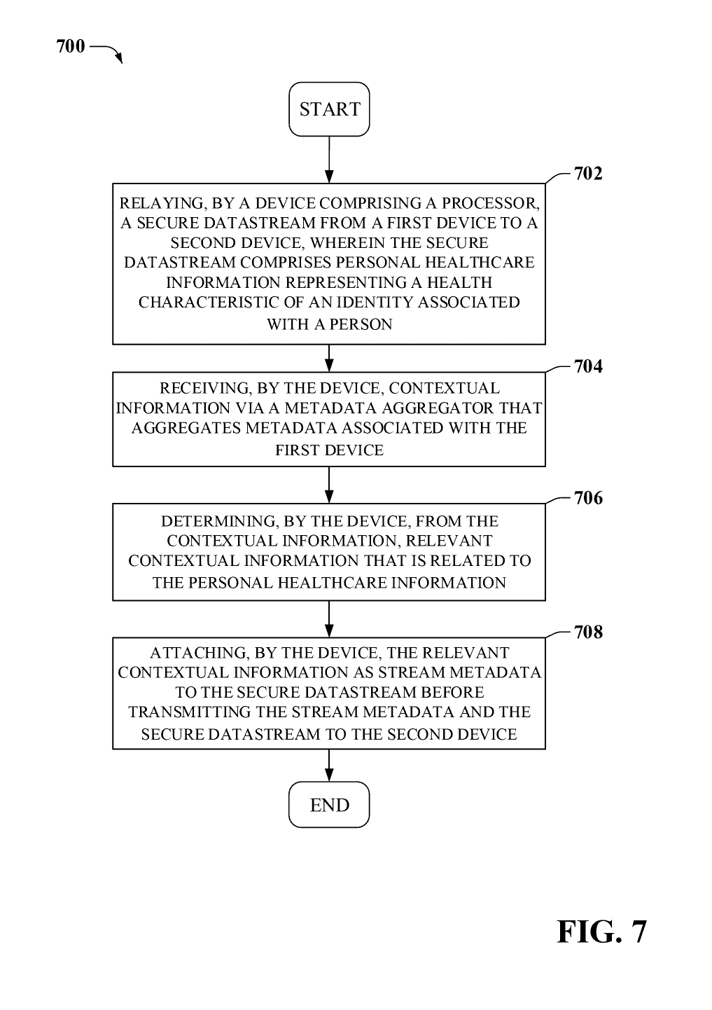

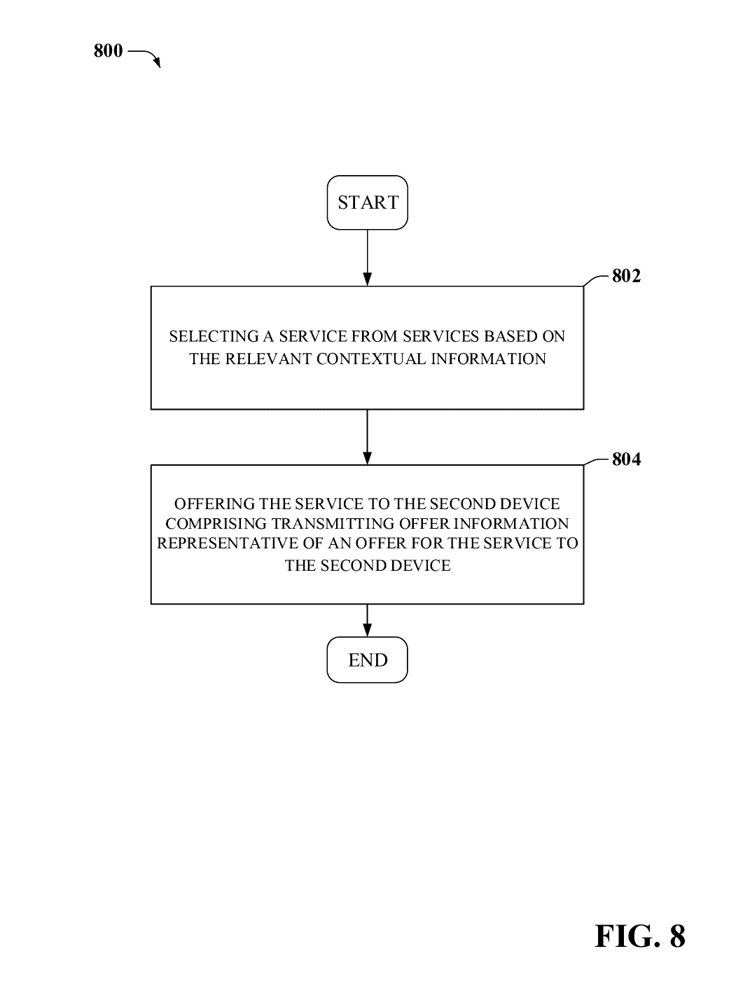

FIGS. 7-8 illustrates a process in connection with the aforementioned systems. The processes in FIGS. 7-8 can be implemented for example by the systems in FIGS. 1-6. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 7 illustrates a flow diagram of an example, non-limiting embodiment of a method 700 for providing contextual metadata for a secure data stream between devices as described herein.

Method 700 can begin at 702 where the method comprises relaying, by a device comprising a processor, a secure data stream from a first device to a second device, wherein the secure data stream comprises personal healthcare information representing a health characteristic of an identity associated with a person.

At method step 704, the method comprises receiving, by the device, contextual information via a metadata aggregator that aggregates metadata associated with the first device. At 706, the method comprises determining, by the device, from the contextual information, relevant contextual information that is related to the personal healthcare information. At 708, the method comprises attaching, by the device, the relevant contextual information as stream metadata to the secure data stream before transmitting the stream metadata and the secure data stream to the second device.

Turning now to FIG. 8, illustrates a flow diagram of an example, non-limiting embodiment of a method 800 for providing contextual metadata for a secure data stream between devices as described herein.

Method 800 can begin at 802 where the method comprises selecting a service from services based on the relevant contextual information. At 804 the method comprises offering the service to the second device comprising transmitting offer information representative of an offer for the service to the second device.

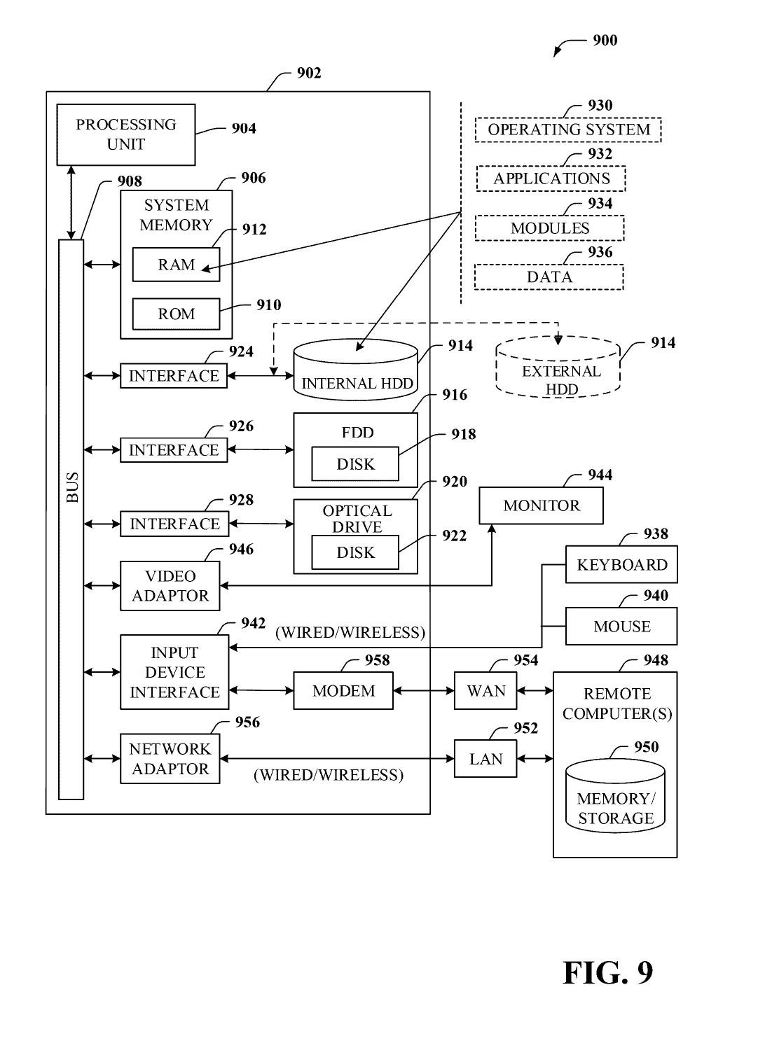

Referring now to FIG. 9, there is illustrated a block diagram of a computing environment in accordance with various aspects described herein. For example, in some embodiments, the computer can be or be included within the radio repeater system disclosed in any of the previous systems 100, 200, 300, 400, 500, and/or 600.

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Non-transitory computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 9, the example environment 900 for implementing various embodiments of the aspects described herein comprises a computer 902, the computer 902 comprising a processing unit 904, a system memory 906 and a system bus 908. The system bus 908 couples system components comprising, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 comprises ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also comprise a high-speed RAM such as static RAM for caching data.

The computer 902 further comprises an internal hard disk drive (HDD) 914 (e.g., EIDE, SATA), which internal hard disk drive 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 912, comprising an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

A user can enter commands and information into the computer 902 through one or more wired/wireless input devices, e.g., a keyboard 938 and a pointing device, such as a mouse 940. Other input devices (not shown) can comprise a microphone, an infrared (IR) remote control, a joystick, a game pad, a stylus pen, touch screen or the like. These and other input devices are often connected to the processing unit 904 through an input device interface 942 that can be coupled to the system bus 908, but can be connected by other interfaces, such as a parallel port, an IEEE 1394 serial port, a game port, a universal serial bus (USB) port, an IR interface, etc.

A monitor 944 or other type of display device can be also connected to the system bus 908 via an interface, such as a video adapter 946. In addition to the monitor 944, a computer typically comprises other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically comprises many or all of the elements described relative to the computer 902, although, for purposes of brevity, only a memory/storage device 950 is illustrated. The logical connections depicted comprise wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 952 through a wired and/or wireless communication network interface or adapter 956. The adapter 956 can facilitate wired or wireless communication to the LAN 952, which can also comprise a wireless AP disposed thereon for communicating with the wireless adapter 956.

When used in a WAN networking environment, the computer 902 can comprise a modem 958 or can be connected to a communications server on the WAN 954 or has other means for establishing communications over the WAN 954, such as by way of the Internet. The modem 958, which can be internal or external and a wired or wireless device, can be connected to the system bus 908 via the input device interface 942. In a networked environment, program modules depicted relative to the computer 902 or portions thereof, can be stored in the remote memory/storage device 950. It will be appreciated that the network connections shown are example and other means of establishing a communications link between the computers can be used.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10BaseT wired Ethernet networks used in many offices.

In an embodiment of the subject application, the computer 1002 can provide the environment and/or setting in which one or more of the dynamic secure mobile network systems disclosed in FIGS. 1-6 can be operated from.

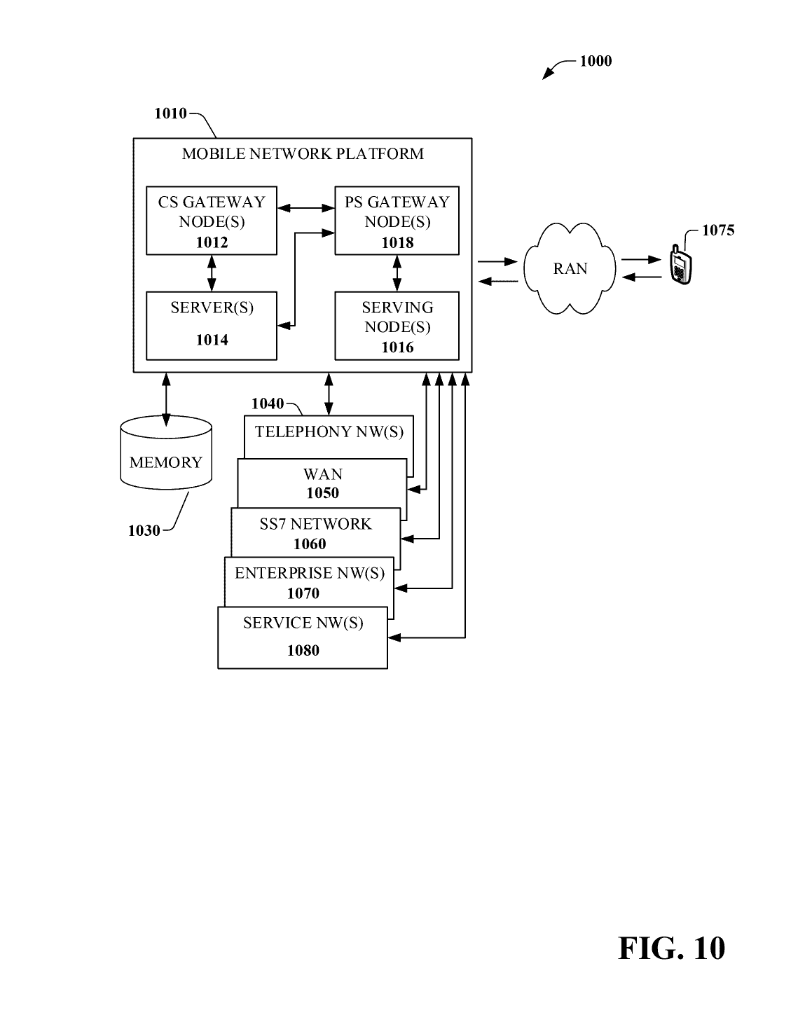

FIG. 10 presents an example embodiment 1000 of a mobile network platform 1010 that can implement and exploit one or more aspects of the disclosed subject matter described herein. Generally, wireless network platform 1010 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 1010 can be included in telecommunications carrier networks, and can be considered carrier-side components as discussed elsewhere herein. Mobile network platform 1010 comprises CS gateway node(s) 1012 which can interface CS traffic received from legacy networks like telephony network(s) 1040 (e.g., public switched telephone network (PSTN), or public land mobile network (PLMN)) or a signaling system #7 (SS7) network 1070. Circuit switched gateway node(s) 1012 can authorize and authenticate traffic (e.g., voice) arising from such networks. Additionally, CS gateway node(s) 1012 can access mobility, or roaming, data generated through SS7 network 1070; for instance, mobility data stored in a visited location register (VLR), which can reside in memory 1030. Moreover, CS gateway node(s) 1012 interfaces CS-based traffic and signaling and PS gateway node(s) 1018. As an example, in a 3GPP UMTS network, CS gateway node(s) 1012 can be realized at least in part in gateway GPRS support node(s) (GGSN). It should be appreciated that functionality and specific operation of CS gateway node(s) 1012, PS gateway node(s) 1018, and serving node(s) 1016, is provided and dictated by radio technology(ies) utilized by mobile network platform 1010 for telecommunication. Mobile network platform 1010 can also comprise the MMEs, HSS/PCRFs, SGWs, and PGWs disclosed herein.

In addition to receiving and processing CS-switched traffic and signaling, PS gateway node(s) 1018 can authorize and authenticate PS-based data sessions with served mobile devices. Data sessions can comprise traffic, or content(s), exchanged with networks external to the wireless network platform 1010, like wide area network(s) (WANs) 1050, enterprise network(s) 1070, and service network(s) 1080, which can be embodied in local area network(s) (LANs), can also be interfaced with mobile network platform 1010 through PS gateway node(s) 1018. It is to be noted that WANs 1050 and enterprise network(s) 1060 can embody, at least in part, a service network(s) like IP multimedia subsystem (IMS). Based on radio technology layer(s) available in technology resource(s) 1017, packet-switched gateway node(s) 1018 can generate packet data protocol contexts when a data session is established; other data structures that facilitate routing of packetized data also can be generated. To that end, in an aspect, PS gateway node(s) 1018 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 1000, wireless network platform 1010 also comprises serving node(s) 1016 that, based upon available radio technology layer(s) within technology resource(s) 1017, convey the various packetized flows of data streams received through PS gateway node(s) 1018. It is to be noted that for technology resource(s) 1017 that rely primarily on CS communication, server node(s) can deliver traffic without reliance on PS gateway node(s) 1018; for example, server node(s) can embody at least in part a mobile switching center. As an example, in a 3GPP UMTS network, serving node(s) 1016 can be embodied in serving GPRS support node(s) (SGSN).

For radio technologies that exploit packetized communication, server(s) 1014 in wireless network platform 1010 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by wireless network platform 1010. Data streams (e.g., content(s) that are part of a voice call or data session) can be conveyed to PS gateway node(s) 1018 for authorization/authentication and initiation of a data session, and to serving node(s) 1016 for communication thereafter. In addition to application server, server(s) 1014 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through wireless network platform 1010 to ensure network's operation and data integrity in addition to authorization and authentication procedures that CS gateway node(s) 1012 and PS gateway node(s) 1018 can enact. Moreover, provisioning server(s) can provision services from external network(s) like networks operated by a disparate service provider; for instance, WAN 1050 or Global Positioning System (GPS) network(s) (not shown). Provisioning server(s) can also provision coverage through networks associated to wireless network platform 1010 (e.g., deployed and operated by the same service provider), such as femto-cell network(s) (not shown) that enhance wireless service coverage within indoor confined spaces and offload RAN resources in order to enhance subscriber service experience within a home or business environment by way of UE 1075.

It is to be noted that server(s) 1014 can comprise one or more processors configured to confer at least in part the functionality of macro network platform 1010. To that end, the one or more processor can execute code instructions stored in memory 1030, for example. It is should be appreciated that server(s) 1014 can comprise a content manager 1015, which operates in substantially the same manner as described hereinbefore.

In example embodiment 1000, memory 1030 can store information related to operation of wireless network platform 1010. Other operational information can comprise provisioning information of mobile devices served through wireless platform network 1010, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1030 can also store information from at least one of telephony network(s) 1040, WAN 1050, enterprise network(s) 1060, or SS7 network 1070. In an aspect, memory 1030 can be, for example, accessed as part of a data store component or as a remotely connected memory store.

In order to provide a context for the various aspects of the disclosed subject matter, FIGS. 9 and 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory (see below), non-volatile memory (see below), disk storage (see below), and memory storage (see below). Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, field programmable gate array, graphics processor, or software defined radio reconfigurable processor and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of the each cell site of the acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to a predetermined criteria which of the acquired cell sites will benefit a maximum number of subscribers and/or which of the acquired cell sites will add minimum value to the existing communication network coverage, etc.

As used in this application, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
receiving a secure data stream from a first device, wherein the secure data stream comprises personal healthcare information representing a health characteristic of an identity associated with a person;
receiving contextual information via a metadata aggregator that aggregates metadata associated with the first device;
determining, from the contextual information, relevant contextual information that is related to the personal healthcare information; and
transmitting the secure data stream and the relevant contextual information, as stream metadata associated with the secure data stream, to a second device.

2. The system of claim 1, wherein the contextual information comprises a location of the first device and an environmental condition determined to be external to the first device.

3. The system of claim 1, wherein the metadata aggregator receives the contextual information from a sensor device on the first device.

4. The system of claim 1, wherein the metadata aggregator receives the contextual information from a third device.

5. The system of claim 1, wherein the metadata aggregator receives the contextual information from a core network management device.

6. The system of claim 1, wherein the operations further comprise:
selecting a service from services based on the relevant contextual information; and
offering the service to the second device comprising transmitting offer information representative of an offer for the service to the second device.

7. The system of claim 1, wherein the metadata aggregator receives contextual information from devices associated with a user account that is associated with the first device.

8. The system of claim 1, wherein the determining the relevant contextual information is based on user account information associated with the second device.

9. The system of claim 1, wherein the determining the relevant contextual information is based on user account information associated with the first device.

10. The system of claim 1, wherein the determining the relevant contextual information is based on a variance in contextual data received over a period of time.

11. The system of claim 1, wherein the operations further comprise:
receiving a request for metadata from the second device via an application programming interface; and
determining relevant contextual information based on request information in the request.

12. A method, comprising:
relaying, by a device comprising a processor, a secure data stream from a first device to a second device, wherein the secure data stream comprises personal healthcare information representing a health characteristic of an identity associated with a person;
receiving, by the device, contextual information via a metadata aggregator that aggregates metadata associated with the first device;
determining, by the device, from the contextual information, relevant contextual information that is related to the personal healthcare information; and
attaching, by the device, the relevant contextual information as stream metadata to the secure data stream before transmitting the stream metadata and the secure data stream to the second device.

13. The method of claim 12, wherein the contextual information comprises a location of the first device and weather information associated with the location.

14. The method of claim 12, wherein the metadata aggregator receives the contextual information from a sensor device on the first device.

15. The method of claim 12, further comprising:
offering, by the device, a service to the second device comprising transmitting offer information representative of an offer for the service to the second device, wherein the service is based on the relevant contextual information.

16. The method of claim 12, wherein the receiving the contextual information further comprises receiving contextual information from devices associated with a user account that is associated with the first device.

17. The method of claim 12,
receiving, by the device, a request for metadata from the second device via an application programming interface; and
determining, by the device, relevant contextual information based on request information in the request.

18. A machine-readable storage medium, comprising executable instructions that, when executed by a processor, facilitate performance of operations, comprising:
relaying a secure data stream from a first device to a second device, wherein the secure data stream comprises personal healthcare information representing a health characteristic of an identity associated with a person;
receiving contextual information via a metadata aggregator that aggregates metadata associated with the first device;
determining from the contextual information, relevant contextual information that is related to the personal healthcare information; and
attaching the relevant contextual information as stream metadata to the secure data stream before transmitting the stream metadata and the secure data stream to the second device.

19. The machine-readable storage medium of claim 18, wherein the operations further comprise:
receiving a request for metadata from the second device via an application programming interface; and
determining relevant contextual information based on request information in the request.

20. The machine-readable storage medium of claim 18, wherein the operations further comprise:
offering a service to the second device comprising transmitting offer information representative of an offer for the service to the second device, and wherein the service is based on the relevant contextual information.
